(19) United States
(12) Patent Application Publication
(10) Pub. No.: US 2007/0264153 A1
(43) Pub. Date: Nov. 15, 2007

(54) Color changing dipstick

(75) Inventor: Theodore Marion Lach III, Round Lake, IL (US)

Correspondence Address: THE MACLEAN FOGG COMPANY;c/o DANA ALDEN, 1000 ALLANSON ROAD, MUNDELEIN, IL, 60060-3890, US

(73) Assignee: MacLean-Fogg Company

(21) Appl. No.: 11/433,744

(22) Filed: May 12, 2006

(51) Int. Cl. G01N 31/22

(52) U.S. Cl. 422/56

(57) ABSTRACT

The present invention relates to a dipstick comprising a measuring portion that includes means for measuring the fluid level in a fluid reservoir, wherein at least a portion of the measuring portion includes a color changing material that is pigmented when subjected to a first temperature and substantially transparent when subjected to a second temperature.

### FIELD OF THE INVENTION

This invention relates to dipsticks for measuring fluid levels in fluid reservoirs.

### BACKGROUND OF THE INVENTION

The measuring of fluid levels in fluid reservoirs often occurs with a dipstick. In practice, the dipstick is inserted within an opening and a portion of the dipstick is submerged in a fluid contained within the fluid reservoir. Once removed from the fluid, the submerged portion will have a coating of fluid on it. The height or level of the coating is then compared to a measuring marker on the dipstick for purposes of measuring the level or relative level of the fluid within the reservoir.

One problem in this area is the inability to accurately identify the level of the coating on the dipstick. For example, certain fluids, such as oil, become less viscous when heated. For such fluids, even in the best lighting conditions, it can be difficult to accurately ascertain the level of coating on the dipstick when the fluids are at an elevated temperature. Another example arises in the context of transmission fluid, which often includes a red dye. The red dye is typically absorbed by plastic parts, such as plastic dipsticks, when submerged in it. In such circumstances, the plastic dipstick acquires a red hue, which makes it difficult to ascertain the true level of the coating.

The present invention is directed to overcoming these and other disadvantages inherent in prior-art systems.

### SUMMARY OF THE INVENTION

The scope of the present invention is defined solely by the appended claims, and is not affected to any degree by the statements within this summary. Briefly stated, a dipstick embodying features of the present invention comprises a measuring portion that includes means for measuring the fluid level in a fluid reservoir, wherein at least a portion of the measuring portion includes a color changing material that is pigmented when subjected to a first temperature and substantially transparent when subjected to a second temperature.

### BRIEF DESCRIPTION OF THE DRAWINGS

FIG. 1 depicts a perspective view of the dipstick of the preferred embodiment.

FIG. 2 depicts a perspective view of the dipstick of the preferred embodiment.

FIG. 3 depicts a bottom view of the dipstick of the preferred embodiment.

FIG. 4 depicts a top view of the dipstick of the preferred embodiment.

FIG. 5 depicts an example of a fluid reservoir.

FIG. 6 depicts the dipstick of the preferred embodiment in relation to a fluid reservoir.

### DETAILED DESCRIPTION OF THE PRESENTLY PREFERRED EMBODIMENT

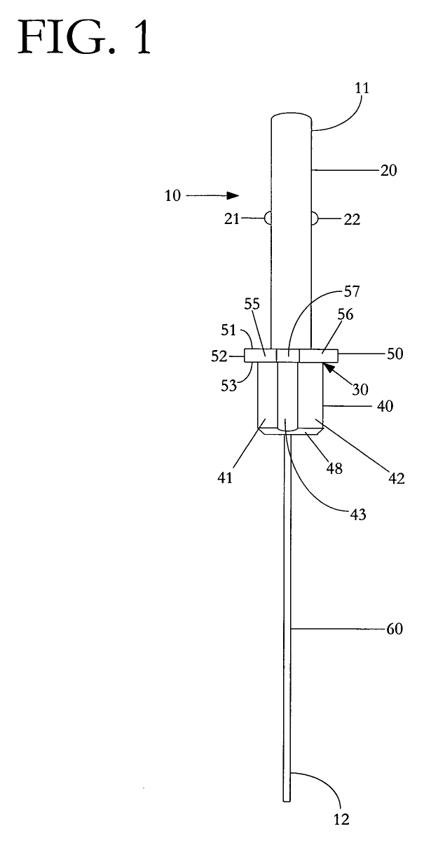

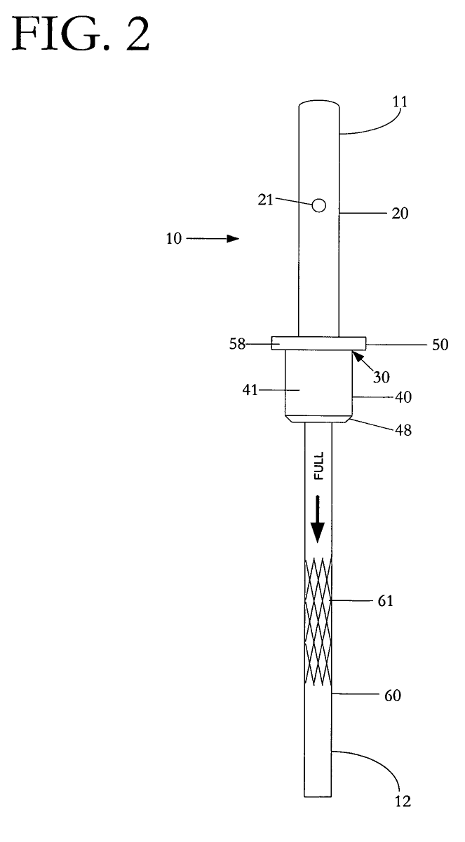

FIG. 1 depicts the presently preferred embodiment of a dipstick 10. As shown therein, the dipstick 10 includes a handle 20. As shown in FIGS. 1 and 2, the handle 20 is located at an end 11 of the dipstick 10.

According to one aspect of the present invention, the handle 20 is shaped to enable a user to grasp the dipstick 10. According to another aspect of the present invention, the handle 20 is shaped to enable a user to remove the measuring portion 60 of the dipstick 10 from a fluid reservoir 100. According to yet another aspect of the present invention, the handle 20 is shaped to enable a user to insert the measuring portion 60 of the dipstick 10 into a fluid reservoir 100. As shown in FIG. 1, the handle 20 of the preferred embodiment is generally cylindrical in shape; however, those skilled in the art will appreciate that it is within the scope of the present invention to provide the handle 20 with any shape so long as it allows a user to grasp the dipstick 10.

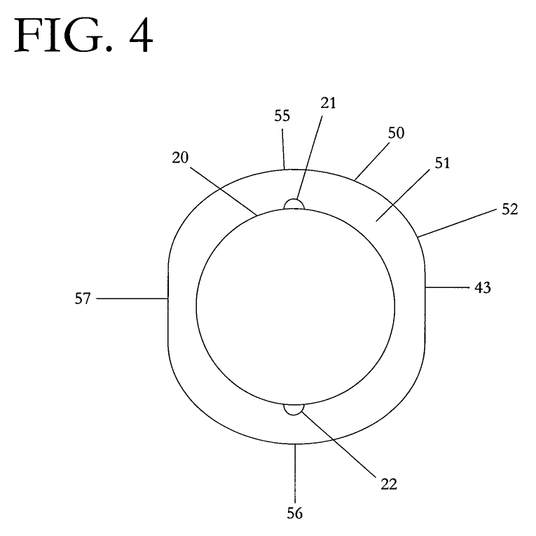

According to one aspect of the preferred embodiment, the handle 20 is configured to be secured to a cap (not shown). As shown in FIGS. 1, 2, and 4, the handle 20 preferably includes a plurality of protrusions 21 and 22 that are provided with a generally spherically shaped outer surface. The protrusions 21 and 22 are configured to retain the cap through a snap fit. Although the dipstick 10 of the presently preferred embodiment retains a cap through a snap fit, those skilled in the art will appreciate that it is within the scope of this invention to secure the cap to the handle 20 via adhesive, welding, molding, crimping, or an interference fit. Furthermore, those skilled in the art will appreciate that it is within the scope of the present invention to provide a handle 20 that is not configured to be secured to a cap.

As shown in FIG. 1, the dipstick 10 of the preferred embodiment includes a sealing portion 30. As shown in FIGS. 1 and 2, the sealing portion 30 is located between the handle 20 and the measuring portion 60. According to one aspect of the preferred embodiment, the sealing portion 30 is shaped to enclose a fluid within a fluid reservoir 100. According to another aspect of the preferred embodiment, the sealing portion 30 is shaped to seal the fluid within the fluid reservoir 100.

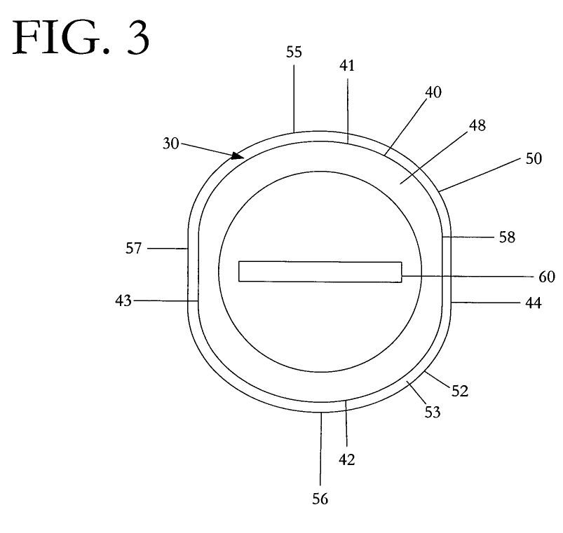

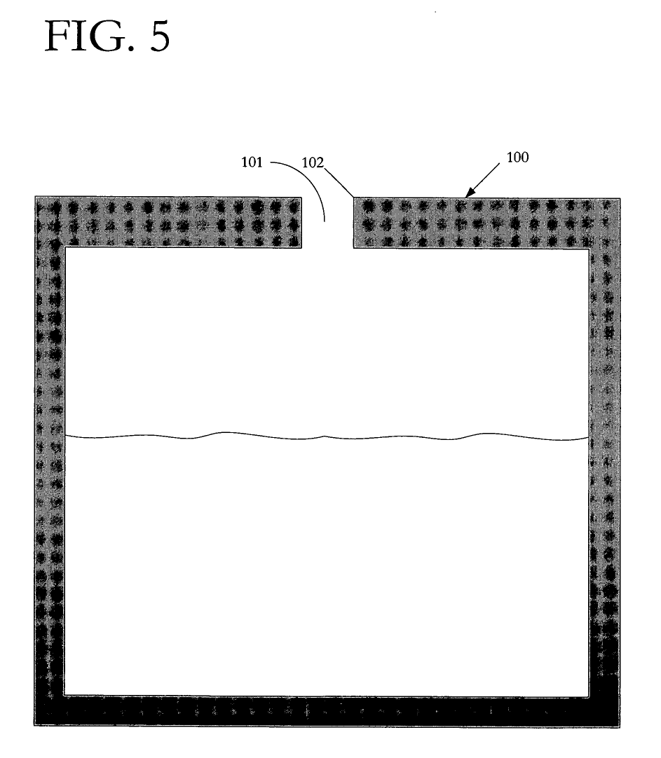

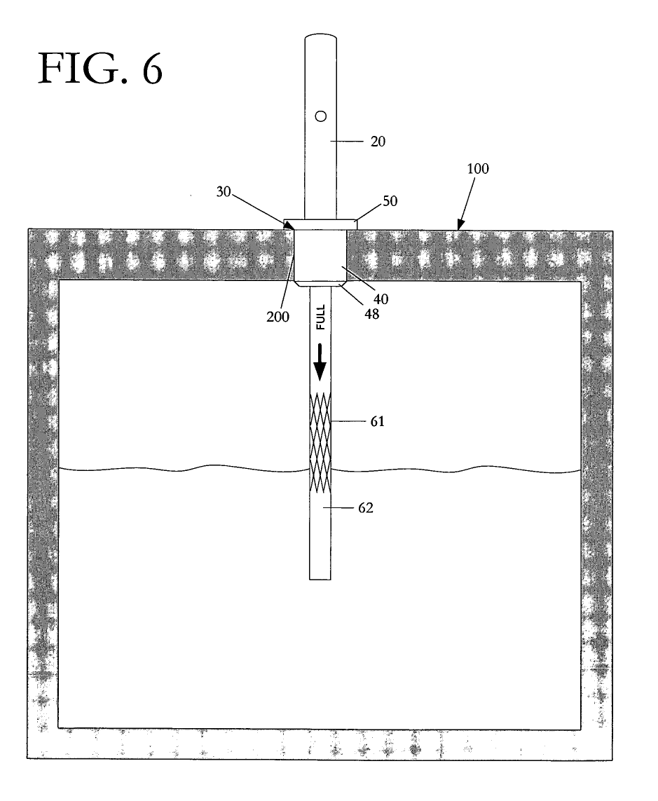

In the preferred embodiment, at least a portion of the sealing portion 30 is shaped generally complementary to an opening 101 (shown in FIG. 5) defined by the fluid reservoir 100 (shown in FIGS. 5 and 6). As shown in FIGS. 1-3 and 6, the sealing portion 30 of the preferred embodiment is provided with a sealing plug 40. As shown in FIG. 6, the sealing plug 40 is shaped to fit within the opening 101 of the fluid reservoir 100 and substantially act as a stopper. As shown in FIGS. 1 and 3, the sealing plug 40 is generally cylindrical in shape and includes a first cylindrical segment 41, a second cylindrical segment 42, a first flat surface 43, and a second flat surface 44. Located adjacent to the sealing plug 40 is a chamfer 48 that eases the insertion of the sealing plug 40 within the opening 101. Those skilled in the art will appreciate that it is within the scope of the present invention to fabricate the dipstick 10 without the chamfer 48 and to provide the sealing plug 40 with any shape so long as it substantially acts as a stopper. By way of example, and not limitation, the sealing plug 40 can be polygonal in shape or threaded and adapted to mate with a threaded opening 101.

In the preferred embodiment, at least a portion of the sealing portion 30 is shaped to cover the opening 101 of the fluid reservoir 100. As shown in FIG. 1-4, the sealing portion 30 of the preferred embodiment is provided with a sealing flange 50. As shown in FIG. 6, the sealing flange 50 is shaped to cover the joint 200 between the sealing plug 40 and the opening 101 of the fluid reservoir 100. In the preferred embodiment, when the dipstick 10 is fully inserted into the opening 101 of the fluid reservoir 100, the sealing flange 50 is located adjacent to an outer end 102 (shown in FIG. 5) of the opening 101 and a portion of the sealing flange 50 is located radially outward from the opening's 101 circumference.

As shown in FIGS. 1 and 2, the sealing flange 50 includes a first surface 51, a second surface 52, and a third surface 53. As shown, the first surface 51 is located adjacent to the handle 20 and extends radially outward therefrom and the third surface 53 is located adjacent to the sealing plug 40 and extends radially outward therefrom. The first and third surfaces 51, 53 are generally flat and generally annular in shape. The second surface 52 is located between the first and second surfaces 51, 53. As shown in FIGS. 1-4, the second surface 52 includes a first cylindrical segment 55, a second cylindrical segment 56, a first flat surface 57, and a second flat surface 58. Those skilled in the art will appreciate that it is within the scope of the present invention to provide the sealing flange 50 with any shape so long as it covers the joint 200 between the seal plug 40 and the opening 101.

Although, in the preferred embodiment, the dipstick 10 is provided with a sealing portion 30 that includes a sealing plug 40 and a sealing flange 50, those skilled in the art will appreciate that it is within the scope of the present invention to fabricate the dipstick 10 without the sealing portion 30, the sealing plug 40, or the sealing flange 50.

As shown in FIG. 1, the dipstick 10 of the preferred embodiment includes a measuring portion 60. As shown in FIGS. 1 and 2, the measuring portion 60 is located at an end 12 of the dipstick 10.

According to one aspect of the present invention, the measuring portion 60 is shaped to fit within the opening 101 of the fluid reservoir 100. According to one aspect of the present invention, the measuring portion 60 is provided with means for measuring the level of fluid within the fluid reservoir 100. As shown in FIGS. 1-3, in the preferred embodiment, the measuring portion 60 is provided with a generally rectangular cross-sectional shape; however, the measuring portion 60 can have any shape so long as it fits within the opening 101.

At least a portion of the measuring portion 60 includes a color changing material. According to one aspect of the present invention, the color changing material is a substance whose color or pigment varies according to temperature. According to another aspect of the preferred embodiment, the color changing material is a substance that is pigmented when subjected to a first temperature and substantially transparent when subjected to a second temperature. According to another aspect of the preferred embodiment, the color changing material is a substance that is pigmented when subjected to a first lower temperature and substantially transparent when subjected to second higher temperature.

According to one aspect of the preferred embodiment, the color changing material is thermochromatic substance. According to one aspect of the preferred embodiment, the color changing material is a liquid crystal. According to another aspect of the preferred embodiment, the color changing material is a dye. Those skilled in the art will appreciate that it is within the scope of the present invention to utilize a color changing material that includes thermochromatic liquid crystals and thermochromatic dyes, and that any combinations thereof can be used.

In the preferred embodiment of the present invention, the color changing material is a thermochromatic leuco dye; and, acceptable results have been derived from the use of a leuco dye sold included in a product sold under the name Chromicolor® and manufactured by Matsui International Company, Inc. Currently, Matsui International Company, Inc offers Chromicolor® in the following standard colors: Fast Yellow, Gold Orange, Vermillion, Pink, Magenta, Fast Blue, Turquoise, Brilliant Green, Fast Black, Green, and Brown. In the preferred embodiment, Fast Blue colored Chromicolor® is used.

In the preferred embodiment, the color changing material becomes substantially transparent at elevated temperatures and pigmented at lower temperatures. The temperature whereat the color changing material will become transparent or pigmented depends on the nature of the color changing material selected. The following chart provides examples of the temperature characteristics for a variety of color changing materials manufactured by Matsui International Company, Inc. and sold under the trademark Chromicolor®:

CHROMICOLOR ® TEMPERATURE RANGE CHART
Regular Type

| Temperature | Color Appears Below | | Color Disappears Above | |
|---|---|---|---|---|
| Type | ° C. | ° F. | ° C. | ° F. |
| 025 | −25.0 | −13.0 | −15.0 | 5.0 |
| 015 | −13.0 | 8.6 | 0.0 | 32.0 |
| 07 | −4.0 | 24.8 | 5.0 | 41.0 |
| 5 | 1.0 | 33.8 | 12.0 | 53.6 |
| 8 | 5.0 | 41.0 | 14.0 | 57.2 |
| 10 | 8.0 | 46.4 | 16.0 | 60.8 |
| 15 | 11.0 | 51.8 | 19.0 | 66.2 |
| 17 | 14.0 | 57.2 | 23.0 | 73.4 |
| 20 | 16.0 | 60.8 | 26.0 | 78.8 |
| 22 | 20.0 | 68.0 | 29.0 | 84.2 |
| 25 | 22.0 | 71.6 | 31.0 | 87.8 |
| 27 | 24.0 | 75.2 | 33.0 | 91.4 |
| 30 | 25.0 | 77.0 | 35.0 | 95.0 |
| 35 | 27.0 | 80.6 | 36.0 | 96.8 |
| 37 | 32.0 | 89.6 | 41.0 | 105.8 |
| 41 | 35.0 | 95.0 | 44.0 | 111.2 |
| 45 | 40.0 | 104.0 | 50.0 | 122.0 |
| 47 | 44.0 | 111.2 | 58.0 | 136.4 |
| 60 | 53.0 | 127.4 | 65.0 | 149.0 |

In the preferred embodiment, Chromicolor® Temperature Type 60 is utilized and the dipstick 10 is colored purple between about −40° C. and about 65° C. and pink between about 65° C. and about 150° C.

Advantageously, once the measuring portion 60 is immersed into a fluid at the requisite elevated temperature, the color changing material becomes substantially transparent and the immersed portion of the measuring portion 60 changes color. As a result, a color discrepancy will appear substantially at the junction between the submerged portion of the measuring portion 60 and the portion of the measuring portion 60 above the fluid line. The location of the color discrepancy can be compared to a measuring marker 61 on the measuring portion 60. Accordingly, the measuring marker 61 provides a means for measuring the fluid level in the fluid reservoir 100.

As shown in FIGS. 2 and 6, the measuring marker 61 of the preferred embodiment includes a plurality of raised lines that form a hatching. Those skilled in the art will appreciate that any form of measuring marker 61 is within the scope of the present invention. By way of example, and not limitation, the measuring marker 61 can include raised markings, depressed markings, substantially planar markings, markings that are formed integrally with the measuring portion 60, markings that are not formed integrally with the measuring portion 60, painted markings, markings in the form of a scale, one or more spaced lines that are generally orthogonal to the axis of the measuring portion 60, lines, shapes, letters, words, or numbers. So long as the measuring marker 61, when compared to the location of the color discrepancy informs a user about the level or relative level of the fluid in the fluid reservoir 100, it is a measuring marker 61 within the scope of this invention.

The dipstick 10 can be fabricated from a variety of materials. In the preferred embodiment, the dipstick 10 includes a composite material and a color changing material. In an alternative embodiment, the dipstick 10 includes a composite material, a reinforcing material, and a color changing material. In another alternative embodiment, the dipstick 10 includes a composite material, a reinforcing material, a color changing material, and a static colored material. In yet another alternative embodiment, the dipstick 10 includes a composite material, a color changing material, and a static colored material.

The dipstick 10 preferably includes a composite material. According to another aspect of the present invention, the composite material is a chemical compound, such as an organic compound. According to another aspect of the present invention, the composite material is a polymer, such as, for example, acrylonitrile butadiene styrene, thermoplastic polyurethane elastomer, polyphenylene sulfide, thermoplastic polyurethane, polybutylene terephthalate, Polypropylene, Polyphthalamide, Phenolic, Polystyrene, and Bulk Molding Compounds. According to yet another aspect of the present invention, the composite material is a plastic. According to one aspect of the present invention, the composite material is a resin. According to still another aspect of the present invention, the composite material is a thermoplastic or thermoset. According to yet another aspect of the present invention, the composite material is a polyamide. According to a further aspect of the present invention, the composite material is a nylon. According to yet a further aspect of the present invention, the composite material is a thermoplastic resin that includes nylon.

In the preferred embodiment of the present invention, the composite material is Nylon 12 Polyamide. Acceptable results have been derived from the use of a Nylon 12 Polyamide included in a product sold under the name Rilsan® Amno by Elf Atochem North America, Inc. The amount of Nylon 12 Polyamide included in the preferred Rilsan® Amno ranges from approximately 97% through approximately 98%, with the balance being a white mineral oil petroleum.

The dipstick 10 is fabricated from a variety of processes. According to one aspect of the present invention, the dipstick 10 is fabricated through molding. According to another aspect of the present invention, the dipstick 10 is fabricated through injection molding. According to yet another aspect of the present invention, the dipstick 10 is fabricated through insert molding. According to yet another aspect of the present invention, the dipstick 10 is fabricated through transfer molding. According to still a further aspect of the present invention, the dipstick 10 is fabricated through compression molding. In the preferred embodiment, the dipstick 10 is fabricating by mixing the color changing material with the other desired constituents and injecting molding the mixture.

The amount of color changing material, by weight, included in a mixture ranges from approximately 0.4% to approximately 4.0% of the mixture, and is preferably approximately 2.0%. In the preferred embodiment, the color changing material is included in Chromicolor® 12-Nylon Conc., which consists of, by weight, approximately 64.0% Thermoplastic polyamide copolymer, approximately 14.0% Ethylene/calcium acrylate copolymer, approximately 20% color changing material in the form of a Thermochromic microcapsule, approximately 2.0% s-Caprolactam (as residue), and other ingredients in amounts that are below reportable levels. Accordingly, in the preferred embodiment, the amount of Chromicolor included, by weight, ranges from approximately 2% to approximately 20%, and is preferably approximately 10%; and the amount of Rilsan® Amno ranges from approximately 80% to approximately 98% and is preferably approximately 90%.

In an alternative embodiment, the dipstick 10 includes a reinforcing material. The reinforcing material can be provided in a plurality of shapes and configurations. According to one aspect of the preferred embodiment, the reinforcing material is in the shape of beads. According to another aspect of the preferred embodiment, the reinforcing material is in a fibrous shape. Those skilled in the art will appreciate that the reinforcing material can include beads and fibers, and that any combination thereof can be used.

According to one aspect of the present invention, the reinforcing material includes a glass. According to another aspect of the present invention, the reinforcing material includes a carbon. According to yet another aspect of the present invention, the reinforcing material includes a graphite. According to a further aspect of the present invention, the reinforcing material includes an aramid. According to still a further aspect of the present invention, the reinforcing material includes a mineral, such as, for example, talc. According to still a further aspect of the present invention, the reinforcing material includes a polymer. Those skilled in the art will appreciate that the reinforcing material can include a glass (fiber or beads), an aramid (fiber or beads), a carbon (fiber or beads), or a graphite (fiber of beads), a mineral, or a polymer (fiber or beads), and that any combinations thereof can be used.

Those skilled in the art will appreciate that the pigment of the color changing material can be selected to enhance the color discrepancy on the measuring portion 60. Similarly, those skilled in the art will appreciate that the amount of the color changing material utilized can be selected to enhance the color discrepancy on the measuring portion 60. Likewise, those skilled in the art will appreciate that the pigment of the composite material and the reinforcing material can be selected to enhance the color discrepancy on the measuring portion 60. Furthermore, those skilled in the art will appreciate that a static colored material, such as, for example, a dye or other material, whose color does not change based on temperature, may be further included in the mixture. For example in applications where the color changing material transitions from blue to transparent and the composite material and reinforcing material, if any, are also blue or a color closely related thereto, a red static colored material may be further included so that the color change is more noticeable.

Although in the preferred embodiment, the entire dipstick 10 includes the color changing material, those skilled in the art will appreciate that it is within the scope of this invention to include the color changing material in only certain portions of the dipstick 10. By way of example, and not limitation, the color changing material may be included only in the measuring portion 60 of the dipstick 10 or in the measuring mark 61 on the measuring portion 60. Furthermore, those skilled in the art will appreciate that it is within the scope of the present invention to include the color changing material in a paint or another substance that is applied onto the surface of any portion of the dipstick 10.

Although in the preferred embodiment, the entire dipstick 10 is integrally formed, those skilled in the art will appreciate that it is within the scope of this invention to fabricate the handle 20, the sealing portion 30, the measuring portion 60, and the measuring marking 61 separately and thereafter combine them to form the dipstick 10. By way of example, and not limitation, the measuring portion 60 may be fabricated and then connected to the handle 20, sealing portion 30, or measuring mark 61. Additionally, those skilled in the art will appreciate that it is within the scope of the invention to fabricate, in whole or in part, the handle 20, the sealing portion 30, and the measuring portion 60 from a metal. Furthermore, those skilled in the art will appreciate that it is within the scope of the invention to fabricate the handle 20, the sealing portion 30, the measuring portion 60, and the measuring marker 61 from different materials. By way of example, the handle 20 may be fabricated from a metal and the measuring portion 60 can be fabricated from a polymer.

While this invention has been particularly shown and described with references to preferred embodiments thereof, it will be understood by those skilled in the art that various changes in form and details may be made therein without departing from the spirit and scope of the invention as defined by the appended claims.

I claim:

1. A dipstick, comprising:
a) a measuring portion that includes means for measuring the fluid level in a fluid reservoir; and
b) at least a portion of the measuring portion includes a color changing material that is pigmented when subjected to a first temperature and substantially transparent when subjected to a second temperature.

2. The dipstick according to claim 1, further comprising a sealing portion.

3. The dipstick according to claim 1, further comprising a sealing portion that includes a sealing plug and a sealing flange.

4. The dipstick according to claim 1, wherein the second temperature is higher than the first temperature.

5. The dipstick according to claim 1, wherein the means for measuring the fluid level in the fluid reservoir include the color changing material.

6. The dipstick according to claim 1, wherein the color changing material is a leuco dye.

7. The dipstick according to claim 1, further comprising:
a) a first end and a second end, wherein:
i) a handle is located at a first end;
ii) the measuring portion is located at the second end;
iii) a sealing portion is located between the first end and the second end;
iv) the color changing material is a leuco dye that is pigmented when subjected to a first temperature and substantially transparent when subjected to a second temperature that is higher than the first temperature; and
v) the handle, the sealing portion, the measuring portion, and the means for measuring the fluid level in the fluid reservoir include the color changing material.

8. The dipstick according to claim 1, further comprising:
a) a first end and a second end, wherein:
i) a handle is located at a first end;
ii) the measuring portion is located at the second end;
iii) a sealing portion is located between the first end and the second end;
iv) the sealing portion includes a sealing plug and a sealing flange; and
v) the handle, the sealing plug, the sealing flange, and the means for measuring the fluid level in the fluid reservoir include the color changing material.

9. A dipstick, comprising:
a) a first end and a second end;
b) a handle located at a first end;
c) a measuring portion located at the second end; and
d) wherein at least a portion of the measuring portion includes a color changing material that is pigmented when subjected to a first temperature and substantially transparent when subjected to a second temperature.

10. The dipstick according to claim 7, further comprising a sealing portion located between the handle and the measuring portion.

11. The dipstick according to claim 7, further comprising a sealing portion that is located between the handle and the measuring portion and includes a sealing plug and a sealing flange.

12. The dipstick according to claim 7, wherein the second temperature is higher than the first temperature.

13. The dipstick according to claim 7, wherein the color changing material is a leuco dye.

14. The dipstick according to claim 7, further comprising:
a) a sealing portion that is located between the handle and the measuring portion and includes a sealing plug and a sealing flange; and
b) the handle, the sealing plug, and the sealing flange include the color changing material.

15. The dipstick according to claim 7, further comprising:
a) a sealing portion that is located between the handle and the measuring portion and includes a sealing plug and a sealing flange; and
b) the color changing material is a leuco dye that is pigmented when subjected to a first temperature and substantially transparent when subjected to a second temperature that is higher than the first temperature;
c) the handle, the sealing plug, the sealing flange, the measuring portion, include the color changing material.

16. A dipstick according to claim 7, further comprising a measuring mark that is provided on the measuring portion.

17. A dipstick, comprising:
a) a first end and a second end;
b) a handle located at a first end;
c) a measuring portion located at the second end;
d) the measuring portion includes a measuring mark;
e) a sealing portion located between the measuring portion and the handle;
f) the sealing portion includes a sealing plug and a sealing flange and
g) the handle, the sealing portion, the sealing plug, the sealing flange, the measuring portion, and the measuring mark include a color changing material, wherein:
i) the color changing material is a leuco dye;
ii) the color changing material is pigmented when subjected to a first temperature;
iii) the color changing material is substantially transparent when subjected to a second temperature; and
iv) the second temperature is higher than the first temperature.
